(19) United States
(12) Patent Application Publication
(10) Pub. No.: US 2010/0329638 A1
(43) Pub. Date: Dec. 30, 2010

(54) METHOD AND APPARATUS FOR INDEPENDENT LICENSING OF AUDIO IN DISTRIBUTION OF AUDIOVISUAL ASSETS

(75) Inventors: Martin Soukup, Ottawa (CA); Robert Kappler, Ottawa (CA)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: Nortel Networks Limited, St. Laurent (CA)

(21) Appl. No.: 12/493,620

(22) Filed: Jun. 29, 2009

(51) Int. Cl. H04N 5/91

(52) U.S. Cl. 386/252; 386/E05.003

(57) ABSTRACT

A method and apparatus is disclosed for enabling and facilitating the licensing of audio portions of audio-video assets per individual copy of the asset. The method and apparatus involves omitting unlicensed portions of the audio content from the asset and instead inserting tags identifying the omitted audio portions and distributing the audiovisual asset, whereupon each individual distributee may obtain licenses for the unlicensed audio portions of the asset and then accessing and playing those audio portions during playback of the asset.

### FIELD OF THE INVENTION

The invention pertains to the distribution of audiovisual assets. More particularly, the invention pertains to the distribution of audiovisual assets in which some of the original audio content is unlicensed at the time of distribution.

### BACKGROUND OF THE INVENTION

Many audiovisual works of art are never widely distributed because of the failure of the artist or production company to obtain rights to portions of the audio content of the work. Specifically, many independent films are produced with soundtracks including musical works of other artists as background, wherein the performance rights for those musical works have not been licensed from their owners. This is true because the creators of the audiovisual works often either do not have the know-how or the resources to obtain such rights or cannot afford to license such rights. Particularly, licensing of intellectual property rights to music typically requires the use of attorneys specializing in such areas of law and can be quite complex and time-consuming. Accordingly, transactional costs of negotiating the licenses can be prohibitive in and of itself. On top of that, the cost of the actual licenses also can be quite significant.

A common scenario is that a motion picture is created and displayed at a film festival with the hope that a large and experienced film distributor will purchase or license the rights to the motion picture and then obtain the licenses to the unlicensed musical or other audio works incorporated therein so that it may publicly display or distribute the motion picture. Another common scenario relates to old television shows for which the licenses to the musical works incorporated into the soundtracks have either lapsed or are limited to certain forms of reproduction or display. For instance, many licenses negotiated in the 1970s and earlier did not contemplate the emergence of the home computer and the Internet and therefore did not grant the right to reproduce or display the musical work on computers or distribute them via computer networks such as the Internet or even in DVD form.

Consequently, a very large portion of all audiovisual works of art are inaccessible to the general public.

An audio, video, or audiovisual work that has been recorded onto a medium is commonly referred to in the relevant industries as an “asset”. Each individual copy of an asset stored or otherwise embedded in a medium is referred to as a copy of the asset. We shall use these terms accordingly in this specification.

### SUMMARY OF THE INVENTION

A method and apparatus is disclosed for enabling and facilitating the licensing of audio portions of audio-video assets per individual copy of the asset. The method and apparatus involves omitting unlicensed portions of the audio content from the asset and instead inserting tags identifying the omitted audio portions and distributing the audiovisual asset, wherein each individual distributee may obtain licenses for and/or copies of the unlicensed audio portions of the asset. The individual distributees then may access and play those audio portions during playback of the audiovisual asset.

### BRIEF DESCRIPTION OF THE DRAWINGS

FIG. 1 is a diagram illustrating data content of an audiovisual asset according to an exemplary embodiment of the present invention.

FIG. 2 is a block diagram of an embodiment of a device for playing audiovisual assets in accordance with an exemplary embodiment of the present invention.

FIG. 3 is a flow diagram illustrating process flow in accordance with one embodiment of the present invention.

### DETAILED DESCRIPTION OF THE INVENTION

Audiovisual assets that are stored or transmitted in digital form (as opposed to an analog form such as film and video tape) usually are stored or transmitted with the video data comprising one or more separable portions or components of the overall file or data stream and the audio portion comprising one or more different separable portions of the file or stream. MPEG, for instance, is a widely used format for encoding audiovisual works in which the audio and video portions of the work comprise separate portions of the overall file or stream. MPEG as well as many other formats for storing and transmitting audiovisual data also may include metadata in additional, separable portions. For instance, a device adapted to play digital media typically needs instructions and other data that do not form a part of the actual audiovisual work per se in order to be able to play the work. This may include, for instance, a table of contents that identifies the start and stop locations in the media of various parts of the work for enabling the player to determine where to start reading data for output to an output device (e.g., a video monitor or an audio speaker). Such metadata also enables the use of such features offered by audio video player devices, such as fast forward, rewind, chapter skip forward, chapter skip backward, pause, stop, etc.

A device designed to play back such digital streams typically reads each of the video and audio portions of the stream (as well as any metadata that discloses how to play, organize, synchronize or otherwise enable the proper playing of the audio and video data), decodes it, equalizes it, possibly converts the digital data into analog form (some types of output devices perform the digital to analog conversion themselves), and outputs it to the appropriate output device, such as a display monitor or speaker. During playback/reproduction, each of these different portions of the overall stream of data (e.g., audio, video, metadata) is commonly referred to as a track (and we also shall refer to them as tracks herein). Thus, at a minimum, such a digital audiovisual asset will comprise one video track that is output to a video monitor such as a television set and one audio track that is output to one or more speakers. It should be understood that the playback “device” may actually comprise a plurality of distinct devices. For instance, in a home theater environment, the system for playing a work recorded on a DVD may comprise a DVD player device and an audio receiver that provide output streams to a video monitor /television and a plurality of speakers.

In the following discussion of exemplary embodiments of the invention, we shall refer to musical works as exemplary unlicensed audio content. However, this is merely exemplary. The unlicensed audio content may comprise virtually any type of audio content.

In accordance with the principles of the present invention, musical works or any other portions of the audio of an audiovisual work can be omitted from the asset and replaced with metadata that sufficiently identifies the musical work. For instance, the musical work may be identified by its unique CDDB identifier or Apple™ ITunes™ identification code.

The audiovisual work can then be distributed in any fashion, such as by radio-wave broadcast, broadcast, multicast, narrowcast, or unicast transmission over a wired or wireless network (such as the Internet), or via physical distribution of a digital storage medium, such as a DVD, containing a copy of the audiovisual work stored in any form of ROM or RAM. The recipient of the work (hereinafter the distributee) can then determine if he or she already owns a copy of and/or the right to reproduce the identified musical works or wishes to purchase or otherwise obtain licenses to play the musical works. After the desired licenses are appropriated (e.g., obtained or determined to already exist), the distributee then obtains copies of the newly licensed musical works and/or locates the copies of the previously licensed musical works previously stored in his or her media library, and inserts them into the audiovisual work for playback of the audiovisual work.

Of course, a commercially-suitable embodiment of the invention comprises an audiovisual playing device that substantially automatically performs most or all of the aforementioned acts. For instance, in one exemplary embodiment, the audiovisual work is input to the playback device including the aforementioned metadata identifying the unlicensed musical works and all the information necessary to insert the unlicensed musical works into the audiovisual work at the proper places during playback provided in one or more metadata tracks. The playback device is able to read this information and obtain copies of the musical works, such as via the Internet or from the distributee's own digital library of musical works should the distributes already own a licensed copy of the musical work. The player then plays back the audiovisual work and inserts the musical works into the playback audio stream at the appropriate times during playback. The musical works may be played directly from the distributee's media library, or an additional copy of the musical work may be made ahead of time depending on the particular embodiment and features that are provided.

For instance, in embodiments in which the musical works need to be pre-processed extensively, it may be advisable to perform the pre-processing ahead of time and store a copy of the processed musical work. For example, in addition to just identifying the musical works and where they need to be inserted during playback, the metadata may include other information instructing the playback device how to play the musical work. Such information may include information as to the relative volume at which the musical work should be played relative to the rest of the soundtrack, equalization data, effects (e.g., echo, reverb, pan, fade, etc.) or any other information to create a complete audio portion of the audiovisual experience desired by the creator of the overall audiovisual work.

In one embodiment of the invention, this metadata is provided in a form such that the player device can read all of this information prior to commencing playback of the audiovisual work so that the audiovisual player device can perform necessary pre-processing of the musical works or even pre-assemble the complete audiovisual work, including the previously unlicensed musical works. Particularly, a significant amount of processing may be required in order to perform all of the aforementioned tasks such that it may not be practical to perform all of the necessary tasks in real time during playback. However, as processor and network speeds become faster, it will become more practical for these tasks to be performed on the fly as an audiovisual work is being downloaded, streamed, or played back.

Furthermore, in a commercially practical embodiment, at least initially, it will likely be desirable to permit some human interaction in the process of collecting the musical works. Particularly, the licenses for the musical works will likely have a cost associated therewith. Accordingly, not only should the player provide some mechanism for the owner to input information necessary for the purchase of licenses (e.g., a credit card number, etc.), but the distributees likely also will want to know the cost of any necessary licenses for musical works prior to purchase so that he or she may make an informed decision as to whether he or she is willing to purchase any or all of those licenses.

Thus, in merely one exemplary embodiment, the playback device first reads this information and determines if any musical library to which the player has connectivity already contains a licensed copy of the work. It then generates a graphical user interface (GUI) informing the user of those musical works to which rights already exist, and displays the cost of obtaining any remaining necessary licenses. The cost information may be included directly in the metadata stored or otherwise associated with the audiovisual work.

Also, information as to where to obtain a copy and license to the musical work may be provided in the metadata. This may be provided in the form of a URL in the Internet from which a copy and license to the musical work may be purchased or otherwise obtained.

However, in other embodiments, the player may have network connectivity so that it can communicate via the Internet or other communication network with one or more websites that offer licenses for the musical works in question to determine the cost of the licenses. This information can be presented to the distributee in any reasonable fashion. For instance, the player may generate a GUI that displays the name of each separately licensable musical work and the cost of the necessary license to it and provide the user the option to obtain the license and a copy of the work. In one embodiment, the system displays the cost of each individually licensable musical work as well as an overall cost to license the entire set and provides the opportunity for the user to license all or any subset of the musical works.

Alternately, it may provide only one cost for the entire package. In yet other embodiments, the audiovisual work may come with two or more alternate soundtracks having different costs and/or themes and the graphical user interface presents all of these options to the user. The different soundtracks need not necessarily be formulated as a function of cost. The creator may provide alternate soundtracks to appeal to persons having different musical tastes. For instance, the creator may offer a classical music soundtrack, a hip-hop music soundtrack, a rock music soundtrack, an ethnic Indian music soundtrack, an ethnic Latin music soundtrack, etc.

The distributes also may be given the option to watch the audiovisual work without the unlicensed musical works or any portion thereof. In yet further implementations, the invention may be combined with social networking concepts wherein individuals not directly connected with the creation of the audiovisual work and/or the musical works incorporated therein may develop alternate soundtracks and make them available through social networking web sites. In accordance with these concepts, a player device may be adapted to further search the Internet for alternate soundtracks offered on social networking web sites and present the distributes with these alternate soundtracks as well as the one(s) identified in the metadata provided with the audiovisual work itself.

In one embodiment, the metadata discloses at least (1) the identity of the musical work, (2) if it is a portion of a larger musical work, the portion of that musical work, and (3) the time within the audiovisual work at which it should be played. However, the metadata may include even further information, such as the relative volume at which the musical work should be played relative to the rest of the audio soundtrack, and sound effects to be applied to the musical works to alter its character from the original recording (e.g., fade, pan, echo, reverb, a wavelet encoding algorithm to be applied to the original recording).

In accordance with yet other embodiments of the invention, if the distributee does not have in his or her media library all of the musical works identified in the metadata, intelligent software may be used to select another musical work from the distributee's media library that is similar to the musical work identified in the metadata. For instance, the ITunes™ Genius™ feature available from Apple™ performs such a function. However, since particular moments with a musical piece often are timed to correspond to events depicted in the video portion of the work, e.g. a crescendo in the music timed to correspond to a particular instant in the video, a more sophisticated algorithm for analyzing the aural properties of the musical work and finding other musical works having similar aural properties may be desired in some cases.

Depending on digital rights management and other legal issues, in other embodiments, the feature of accessing of musical works from pre-existing libraries may be omitted, and all musical works identified in the metadata as described hereinabove may be permitted to be obtained only through one or more forms of licenses obtained specifically for the audiovisual work. The form of the licenses may be any reasonable form and the present invention is not limited by any particular form of license. For instance, one time licenses may be offered. For greater cost, the distributes may be permitted to buy a permanent license to play the musical works in connection with the audiovisual work. In yet other licensing arrangements, the distributee may be permitted to purchase a broad-based license that permits the purchaser to purchase the musical works for playback both in association with the audiovisual work and separately therefrom (similarly to one who purchases a compact disk containing a musical work). In such cases, it is envisioned that the purchaser may purchase the entire musical work for storage in his or her musical library even if only a portion thereof forms part of the soundtrack of the audiovisual work. The GUI may present any or all such options to the user.

Likewise, when a copy of a musical work is found in the user's library, the device may further determine the nature of the license to the work that the user has and, particularly whether it permits the user to perform the work in association with the audiovisual work. If so, then it can be associated with the audiovisual work. If not, then the device may present the user with a GUI that allows the user to purchase or otherwise obtain a license to do so.

In any event, after the preliminary steps of obtaining the necessary licenses to and copies of the musical works, the playback device can then play back the audiovisual work and insert the now-licensed musical works into the overall soundtrack at the appropriate places.

In one embodiment, the player may assemble the entire work prior to playback. In other embodiments, the player may assemble the previously-omitted musical works with the remainder of the audiovisual work on the fly during playback. In yet other embodiments, the player may assemble the complete audiovisual work and create a new physical copy of the completed work that the distributee may possess permanently. The player may be configured to, when a musical work is purchased, also place it permanently in the distributee's digital musical library apart from the completed audiovisual work.

In the case of newly created audiovisual works, they may be created from the start with the present invention in mind, that is, with the actual unlicensed musical works omitted, and instead containing metadata identifying the musical work and other relevant information already in the form set forth herein. In the case of audiovisual assets stored in digital form that contain unlicensed musical works, the owner commonly will have the different portions of the overall soundtrack in separate original tracks. Hence, it should be a simple matter to create a new copy of the work excluding the unlicensed audio components and replaced with identifying metadata.

In the case of older audiovisual recordings, whether they be stored digitally or in analog form (e.g., old television programs for which the original audio master tapes are not available), the unlicensed audio portions could be removed from the audio/visual works using modern audio post-processing software to eliminate the unlicensed audio portions while leaving the remaining audio portions intact. Audio post-processing software packages are available that are designed precisely for such tasks as removing unwanted portions of audio recordings.

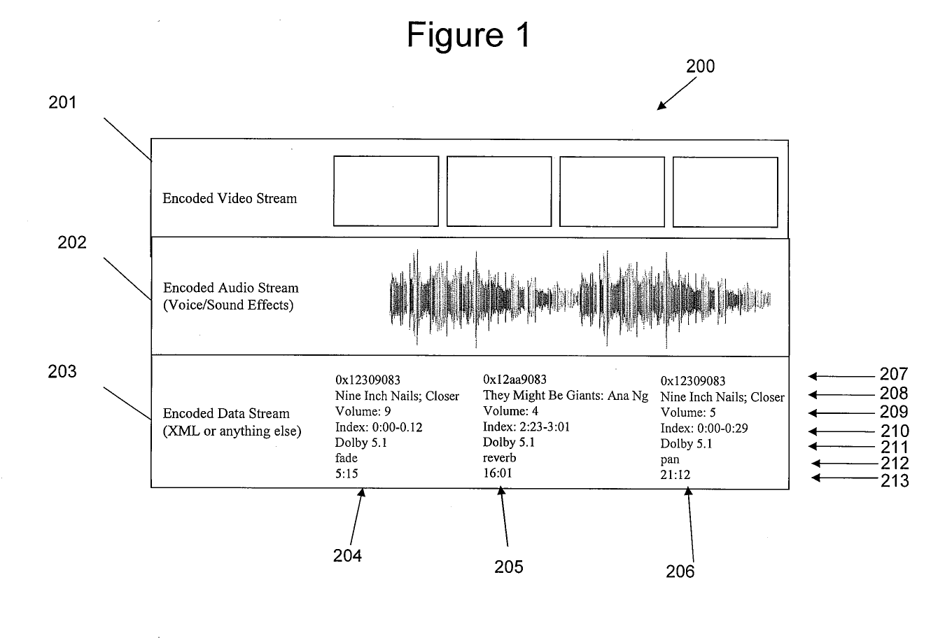

FIG. 1 is a diagram illustrating three exemplary tracks of data that may comprise a digital audiovisual asset 200 in accordance with the principles of the present invention. A first track 201 comprises the encoded video for the work. A second track 202 comprises the licensed audio stream, which typically might include the dialog, any sound effects, and any licensed music. Finally, a third track 203 comprises meta data providing all necessary information for permitting the distributee's playback system to obtain copies of the unlicensed audio portions and insert them into the playback of the audiovisual work at the proper instances, for the proper durations, and with the appropriate equalization, volume and/or other effects.

In this simple example, the unlicensed audio comprises three excerpts from commercially available musical works (e.g., musical works that are publicly available apart from the present audiovisual work). These may, for instance, be works of popular music which are available for purchase on CD or via download over a computer network such as the Internet. The metadata track 203 discloses, for each separate unlicensed audio portion 204, 205, 206, a unique ID 207 specifically identifying the audio work. This may take any form. For musical works, it may be the CDDB ID or an Apple™ ITunes™ ID. In addition, it may also include the actual name of the audio work and/or artist 208. This would permit the player device to display the artist and song title to the user before he or she decides to purchase it without the need for connectivity to the Internet or an external database such as the CDDB website. The metadata further includes the relative volume 209 at which the audio portion should be played, a time index 210 within the audio work at which play should be started and stopped, the encoding scheme of the audio 211, any effects (such as fade, reverb, pan, speed, etc.) that should be applied to the audio portion 212, and the time index 213 within the audiovisual work at which it should start playing.

The example described above is highly simplified. In more robust embodiments, the effects information, for example, may be much more detailed and include specific parameters or algorithms for the special effects.

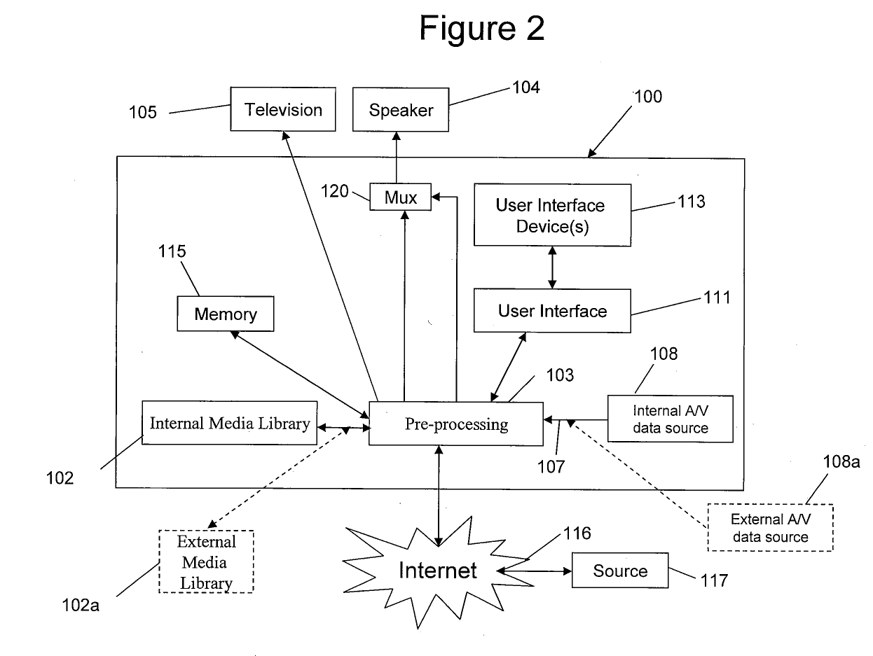

FIG. 2 is a block diagram illustrating several potential embodiments of a multimedia player device in accordance with the principles of the present invention. In one such embodiment, the player device 100 is an all-in-one type multimedia player device, in which essentially all of the functionality is provided in a single box. The device 100 includes an audiovisual pre-processing block 103. Pre-processing block 103 performs all of the conventional processing of an input audio and video stream to generate output streams for audio and video monitoring devices such as speakers 104 and televisions 105 for rendering an audiovisual work for consumption by a consumer. The functionality of block 103 may, for example, be provided by any one or more of a microprocessor, a digital signal processor, software, digital circuitry, combinational logic, state machines, Field Programmable Gate Arrays (FPGAs), analog circuitry, and combinations thereof. Furthermore, in this particular embodiment, the device 100 also incorporates a memory 102 containing the user's musical library directly within it. Of course, in other embodiments, the multimedia player 100 may alternately or additionally have connectivity to a separate, external digital music library storage device 102a, such as an IPod™ or general purpose computer running digital audio storage and organizing software such as Apple™ ITunes™ or Windows MediaPlayer™ or any other digital media storage device on which a person might store a digital music library. In some embodiments, the media library, whether internal or external, may comprise a CD carousel containing a number of compact disks.

The pre-processing block 103 is adapted to receive an input audiovisual data stream 107 comprising at least a video track, and a metadata track, the metadata track including at least metadata identifying any unlicensed audio portions of the overall soundtrack of the audiovisual work and where they belong in the work. In most cases, there will also be at least one audio track including the audio portions of the audiovisual work that are properly licensed (or do not require a license). The stream 107 may be provided from an internal digital media playing device 108, such as a DVD (Digital Versatile Disk) player, a DVR (Digital Video Recorder), a hard disk, a solid state memory, etc. or a external source 108a (shown in phantom), such as streaming data over the Internet or other communication network, an external digital media player, such as an IPod™, an external DVD player, an external DVR, a general purpose computer, etc.

Preprocessing block 103 receives the incoming stream 107 of data comprising the various tracks of the audiovisual work and parses it into the individual separate tracks, comprising, for example, a video track, a licensed audio track, and a metadata track. It pre-processes the video and audio tracks per a conventional multimedia player to prepare the data for reproduction on the monitoring devices 104, 105. This may include such tasks as data decompression, data decoding, equalization, and digital to analog conversion. The pre-processing block 101 may store the decompressed and decoded audiovisual work in a local memory 115 and/or in the media library 102 along with its owner's other digital media. The pre-processing block 103 also is adapted to extract the aforementioned metadata from the incoming digital data stream 107, determine if the digital music library 102, 102a already contains any of the musical or other audio works identified in the metadata. If so, it preprocess them as indicated in the metadata. This may include extracting the appropriate portions of those musical works, equalizing them, adding effects, setting relative volumes, and storing the data in a memory, such as local memory 115, in one or more digital tracks ready for playback. For those musical works identified in the metadata for which a suitably licensed copy does not previously exist in the digital media library 102, 102a, the pre-processing block 103 attempts to access copies thereof over the Internet 116 or other communication network with connectivity to one or more sources 117 of the unlicensed musical works.

As previously mentioned, these sources may include well-known websites such as Napster™, the iTunes™ store, and Rhapsody™ that offer such audio works for sale or license. In other embodiments, a web site may be set up strictly to service requests in accordance with the present invention. In the latter case, a system may be set up by which persons may license and obtain copies of musical works only for use in connection with the playing of the corresponding audiovisual work and only the portions of the musical works that are called for within the audiovisual work. Such a license presumably could be offered for substantially less cost than outright purchases of each entire musical work. Of course, it is not necessary that a separate website be set up for this purpose. Any of the aforementioned well-known websites may be adapted to offer such licenses and copies in addition to the more conventional licenses and complete copies of musical works presently offered.

In any event, the pre-processing block 103 interfaces with the website or other source 117 of the musical works to purchase and download the musical works and store them in the memory 115 and/or also add them to the musical library 102, 102a.

In addition, the device 100 may include user interface software and/or circuitry 111 as well as one or more user interface devices 113 such as a display screen, a keyboard, a touch screen, a mouse, a series of user-operable buttons, etc., that allows the device 100 to present to a user one or more options for purchasing unlicensed musical works and to permit the user to input responsive instructions, all as previously described hereinabove.

After the preprocessing block 103 collects all of the necessary musical works and pre-processes them as needed to be ready for playback, it may create and store a supplemental audio track containing all of the supplemental audio. In this exemplary embodiment, when the user operates the device 100 to playback the audiovisual work, the player starts to output the video track and any audio track(s) provided with the audiovisual work to the output devices 104, 105. Simultaneously, the pre-processing block starts to output the supplemental audio track to a multiplexer 120 that will multiplex the supplemental audio track with the other audio track(s) provided with the audiovisual work and output the multiplexed signal to one or more speakers.

FIG. 2 is merely one simplified example of a device that performs the various functions in accordance with the principles of the present invention. There are many other ways to implement the principles of the present invention. For instance, rather than creating a complete supplemental audio track prior to playing, the supplemental audio can be added on the fly during playback. In one possible implementation, tags may be placed in a meta data stream slightly ahead of the time that a supplemental audio piece is to be played and the supplemental audio portion can be retrieved from the digital library 102, 102a, memory 115, or via the Internet 116 or another communication network at that time. In accordance with yet another embodiment, the invention may be implemented by means of a pre-processing device that simply acts as an analog or digital source to a separate, conventional media player and/or digital media storage device. Even further, in any of the aforedescribed embodiments, after obtaining licenses and copies of the unlicensed audio works, the device may automatically, or subject to a user input and/or DRM (Digital Rights Management), create a conventional DVD or other permanent recording of the completed audiovisual work that can then be played on other audiovisual player devices in a conventional manner.

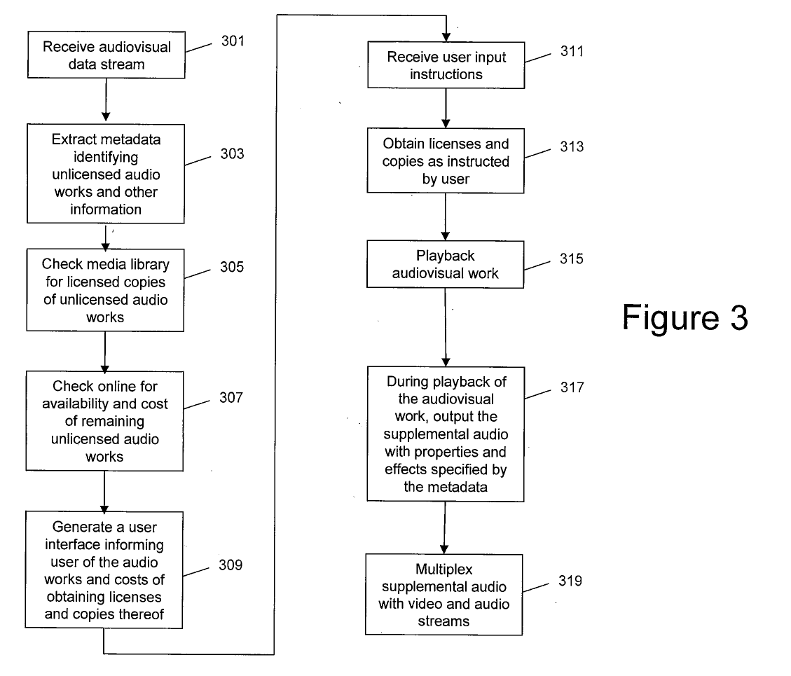

FIG. 3 is a flowchart illustrating operation of an audiovisual playing device in accordance with one exemplary embodiment. In step 301, the device receives an audiovisual stream comprising at least a video track and a metadata track, and probably at least one audio track. In step 303, the device extracts the metadata for each unlicensed audio work. In step 305, the device checks any digital media library to which it has connectivity to determine if the recipient already owns a license and copy of any of the audio works identified within the metadata. In step 307, with respect to any audio works not already owned by the recipient, the device accesses an external source from which licenses and copies of the remaining works may be obtained

Next, in step 309, the device presents the user with at least one option for purchasing the remaining unlicensed audio works. The user inputs his or her instructions as to which audio works to download and, in step 311, the device receives that input. In step 313, the device obtains the licenses and copies of those works. This may include paying for the audio works and then downloading copies thereof. In step 315, responsive to the device being operated to playback the audiovisual work, the device plays back the video and, if provided audio tracks of the audiovisual work. In step 317, the device outputs the supplemental audio track to insert the supplemental audio works at the times indicated in the metadata relative to the video stream and conditioned according to any instructions in the metadata such as equalization parameters, relative volume, and effects. In step 319, the device multiplexes the supplemental audio with the other audio track(s) of the audiovisual work to reproduce a complete audiovisual work including the supplemental audio works.

While the invention has been described primarily in connection with audiovisual works comprising unlicensed musical works, it should be understood that the principles of the invention can be applied to insert any omitted audio works into an audiovisual work. In fact, the invention is not even limited to the obtaining and inserting of only audio works. The invention could be implemented, in the appropriate circumstances, to insert video works into audiovisual works. For example, music videos may be downloaded to go along with musical works using the principles of the present invention.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of distributing an audiovisual work comprising an audio portion and a video portion, the method comprising:
conveying a copy of the audiovisual work from a distributor to a recipient, the copy comprising first data containing the video segment of the audiovisual work, and second data identifying a first audio work comprising a first portion of the audio segment of the audiovisual work, the copy of the audiovisual work not containing a copy of the first audio work;
the recipient reading the second data to determine the identity of the first audio work;
the recipient obtaining, separately from the conveying of the copy of the audiovisual work, a copy of the first audio work; and
the recipient playing back the video segment in combination with the copy of the first audio work to reproduce the audiovisual work.

2. The method of claim 1 wherein the copy of the audiovisual work further comprises third data containing a second audio work comprising a second portion of the audio segment of the audiovisual work and wherein the playing back of the audiovisual work further comprises combining the second audio work with the first audio work and the video segment of the audiovisual work.

3. The method of claim 3 wherein the second data further comprises information describing a position within the audiovisual work where the first audio work is to be inserted.

4. The method of claim 3 wherein the second data further comprises an audio effect to be applied to the first audio work further comprising pre-processing the copy of the first audio work in accordance with the audio effect.

5. The method of claim 4 wherein the reading, obtaining, and pre-processing is performed prior to the playing back.

6. The method of claim 3 wherein the second data further comprises at least one of (a) information describing an equalization parameter for the first audio work, (b) information describing a volume of the first audio work, (c) information describing an encoding scheme of the first audio work, and (d) a wavelet encoding scheme to be applied to the first audio work.

7. The method of claim 3 wherein the first audio work comprises at least a segment of a musical work that is available for purchase or licensing separately from the audiovisual work and wherein the second data further comprises information defining a segment of the musical work that comprises the first component of the audio portion.

8. The method of claim 3 wherein the obtaining of the first audio work comprises downloading a copy of the first audio work via a communication network.

9. The method of claim 3 wherein the obtaining of the first audio work comprises searching a digital library of copies of audio works owned by the recipient for the first audio work.

10. The method of claim 9 wherein the obtaining of the first audio work further comprises determining if the recipient owns a license to the first audio work that permits the first audio work to be performed in combination with the audiovisual work.

11. The method of claim 9 wherein the obtaining of the first audio work further comprises purchasing a copy of and license to the first audio work only if the digital library does not already contain a copy of the first audio work.

12. The method of claim 3 wherein the second data further comprises at least one of (a) information disclosing the cost of a license for the first audio work and (b) information disclosing where a license to the first audio work may be obtained.

13. The method of claim 3 wherein the second data comprises a plurality of audio works that may be optionally used as the first audio work and wherein the obtaining further comprises the recipient selecting a one of the plurality of audio works to be used as the first audio work.

14. The method of claim 9 further comprising:
if the digital library does not contain a copy of the first audio work, analyzing the first audio work for aural properties;
determining if the digital library contains a copy of another audio work having similar aural properties to the analyzed aural properties of the first audio work; and
playing back the video portion in combination with the another audio work as a substitute for the first audio work to reproduce the audiovisual work.

15. The method of claim 1 further comprising:
accessing via a communication network a web site offering an alternate audio work as a substitute for the first audio work within the audiovisual work.

16. A method of reproducing an audiovisual work comprising a video segment and an audio segment, the method comprising:
receiving a copy of the audiovisual work in digital form, the copy comprising first data containing the video segment of the audiovisual work, and second data identifying a first audio work comprising a first portion of the audio segment of the audiovisual work, the copy of the audiovisual work not containing a copy of the first audio work;
reading the second data to determine the identity of the first audio work;
obtaining a copy of the first audio work from a source separate from the copy of the audiovisual work;
combining the video segment with the first audio segment to create a new version of the audiovisual work including the first audio work.

17. The method of claim 16 wherein the copy of the audiovisual work further comprises third data containing a second audio work comprising a second portion of the audio segment of the audiovisual work and wherein the combining comprises combining the second audio work with the first audio work and the video segment.

18. The method of claim 17 wherein the obtaining comprises searching a digital library of audio works to determine if a copy of the first audio work is available therein and, if available, obtaining the copy of the first audio work from the digital library.

19. The method of claim 18 wherein the obtaining further comprises, if a copy of the first audio work is not available in the digital library, connecting via a network to a server from which a copy of the first audio work may be obtained and obtaining a copy of the first audio work from the server.

20. The method of claim 17 wherein the obtaining further comprises connecting via a network to a server from which a copy of eh first audio work may be obtained and obtaining a copy of the first audio work from the server.

21. The method of claim 20 wherein the obtaining of the copy of the first audio work from the server further comprises obtaining a license to the first audio work that permits the first audio work to be performed as part of the audiovisual work.

22. The method of claim 21 wherein the obtaining further comprises paying for the license and the copy.

23. The method of claim 21 wherein the obtaining a license comprises obtaining a license to perform the first audio work separately from the audiovisual work.

24. The method of claim 21 further comprising:
displaying to a user a plurality of options with respect to obtaining a copy of the first audio work prior to the obtaining; and
receiving an input from the user selecting one of the options.
wherein the options include a plurality of different types of licenses to the first audio work.

25. The method of claim 18 wherein the second data further comprises at least one of (a) information disclosing the cost of a license for the first audio work and (b) information disclosing where a license to the first audio work may be obtained.

26. The method of claim 16 further comprising:
displaying to a user a plurality of options with respect to obtaining a copy of the first audio work prior to the obtaining; and
receiving an input from the user selecting one of the options.

27. The method of claim 16 wherein the second data further comprises at least one of (a) information disclosing the cost of a license for the first audio work and (b) information disclosing where a license to the first audio work may be obtained.

28. The method of claim 26 wherein the second data comprises a plurality of audio works that may be optionally used as the first audio work and wherein the offering comprises offering the user the option of selecting one of the plurality of audio works.

29. The method of claim 16 further comprising:
accessing via a communication network a web site offering an alternate audio work as a substitute for the first audio work within the audiovisual work.

30. A medium bearing a copy of an audiovisual work comprising first data containing a video segment of the audiovisual work, and second data identifying a first audio work comprising a first portion of the audio segment of the audiovisual work, the copy of the audiovisual work not containing a copy of the first audio work.

31. The medium of claim 30 wherein the second data further comprises information disclosing a way to obtain a copy and license to the first audio work.

32. The medium of claim 31 wherein the information disclosing a way to obtain a copy of and license to the first audio work comprises a web address at which a copy and license to the first audio work may be obtained.

33. The medium of claim 32 wherein the second data further comprises information disclosing a cost of obtaining a copy of and license to the first audio work.

34. The medium of claim 30 further comprising third data containing a second audio work comprising a second portion of the audio segment of the audiovisual work

35. The medium of claim 34 wherein the second data further comprises an audio effect to be applied to the first audio work.

36. The medium of claim 30 wherein the first audio work comprises at least a segment of a musical work that is available for purchase or licensing separately from the audiovisual work and wherein the second data further comprises information defining a segment of the musical work that comprises the first component of the audio portion.

37. The medium of claim 30 wherein the second data further comprises information disclosing a cost of obtaining a copy of and license to the first audio work.

38. The medium of claim 30 wherein the second data comprises a plurality of audio works that may be optionally used as the first audio work.

39. The medium of claim 30 wherein the medium is a DVD.

40. The medium of claim 30 wherein the medium is a signal transmitted over a communication network.
